(19) United States
(12) Patent Application Publication
(10) Pub. No.: US 2013/0084781 A1
(43) Pub. Date: Apr. 4, 2013

(54) APPARATUS AND METHOD FOR WORKING AN OPTICAL LENS

(71) Applicant: Gunter Schneider, Marburg (DE)

(72) Inventor: Gunter Schneider, Marburg (DE)

(73) Assignee: SCHNEIDER GMBH & CO. KG, Fronhausen (DE)

(21) Appl. No.: 13/702,126

(22) PCT Filed: Sep. 29, 2011
(86) PCT No.: PCT/EP2011/004866

§ 371 Date: Dec. 5, 2012

(30) Foreign Application Priority Data
Oct. 4, 2010 (EP) 10 013 265.3
Nov. 5, 2010 (EP) 10 014 335.3

(51) Int. Cl. G05B 15/02; B24B 13/06; G02C 7/02

(52) U.S. Cl. CPC G05B 15/02; G02C 7/02; B24B 13/06
USPC 451/5; 83/452; 269/86; 29/592; 82/1.11; 83/13; 700/83

(57) ABSTRACT

An apparatus and a method for processing an optical lens are proposed, whereby the desired optical data of the lens can be input into the device and lens-production data and/or geometric data of the lens are determined therefrom to control the processing of a surface side of the lens.

### BACKGROUND OF THE INVENTION

1. Field of the Invention

This invention relates to an apparatus for processing an optical lens as well as a method for processing an optical lens.

2. Description of Related Art

An optical lens, for example for eyeglasses, is to have certain optical properties. The associated desired optical data of the lens are determined by, for example, an optician. These data comprise, for example, the indication of diopters, data regarding sphere and cylinder, pantoscopic angle, etc. In addition, these desired optical data can also contain the distance from and/or the position relative to an assigned eye, in particular in the case of incorporation in a certain eyeglass frame, i.e., e.g., the pantoscopic angle, facial angle or face form angle, interpupillary distance, etc.

In the past, lenses with predetermined optical data, for example with diopters available in various stages, were used. To an increasing extent, however, lenses are used that have the individualized optical data that are desired in each case or the associated optical properties. Such lenses are then processed or finished based on the optical data that are desired in each case, whereby the lenses are provided in particular with so-called free-form surfaces (for example, progressive-addition lenses, etc.). The description below and this invention relate to those lenses or lens blanks that are processed according to the desired, individualized optical data and are provided in particular with the thus mentioned free-form surfaces.

At present, the desired optical data are usually relayed to a large-scale operation, such as a central laboratory, or the like, where the corresponding geometric data of the lens are determined from the desired optical data by means of a design model in a central processing device that is separate and independent from the processing machines. The thus obtained geometric data of the lens are relayed to a central processing and sequence control unit. Subsystems then generate corresponding processing orders with production data for various processing machines to process the lenses based on the specific geometric data. In addition to the partial problematic transfer of the desired optical data from the optician to the large-scale operation, this data processing requires extraordinarily high hardware, software and machine expenses; in particular, usually corresponding servers and computer networks are used for this purpose. In addition, the operation requires the use of specially trained staff. Consequently, labor costs are also high.

With respect to the cost that has been necessary to date and the necessary integration of server systems, etc., into computer networks or the Internet, reference is made by way of example to U.S. Pat. No. 5,808,894 A, US 2004/0246440 A1, and WO 2010/040757 A1.

DE 198 04 542 A1 relates to the edge processing of an eyeglass lens. From input optometric data, eyeglass frame data, data for visual centers of the eyes, and additional customer data, raw glass is calculated on a computer with respect to the necessary diameter, the radii of the optical front surface and rear surface as well as the optimum center thickness, based on the type of eyeglass material, and relayed via remote data transmission to an eyeglass lens manufacturer for the purpose of creating a raw glass. The raw glass that is delivered by the glass manufacturer is then finished by shape processing or shape grinding. This means that the edge of the raw glass is adapted to the eyeglass frame and in this connection is optionally provided with a bevel, a groove or a bezel. In DE 198 04 542 A1, the shape processing relates to the edge processing. In this case, DE 198 04 542 A1 also discloses an optional processing of an optical surface of the raw glass, but without indicating details in this regard. Based on the context and the structure of the grinding device shown in DE 198 04 542 A1, in this case, this is obviously a processing of the edge, but not a processing of the front side or rear side to achieve desired optical values or properties in the eyeglass frame.

The above-explained, complex and multi-stage organization of the processing of optical lenses has already been improved relative to the processing sequence. DE 10 2007 007 188 A1 discloses a processing center for processing an optical lens that is made of plastic. This processing center forms the starting point of this invention. It has a workpiece spindle that rotates around a rotational axis, with a receptacle for a lens. The processing center also has a processing device with a milling tool, a processing device with a turning tool, a polishing device, a cleaning device, and an engraving device. The workpiece spindle can be moved in the direction of the rotational axis and crosswise thereto to feed the lens to the different devices and to make possible the various processing work and in this case in particular to generate the desired free-form surfaces on the lenses.

In DE 10 2007 007 188 A1, there is no mention of a control unit of the processing center. It can be assumed from this, however, that the processing center has a computer-supported control device, such as a CNC control unit, so that the different devices can operate in the usual way corresponding to the preset production data. To operate, the known processing center then has to be connected accordingly to a computer network or the like for the preparation of the production data.

EP 1 927 432 A1 discloses an eyeglass lens lens-processing system, whereby shape data, i.e., geometric data, are input for an eyeglass lens by means of a data input device, and the eyeglass lens that is based on these data is processed. A determination of geometric data or production data from desired optical data is not carried out. Rather, this is a question of the adaptation of an eyeglass lens to an eyeglass frame.

WO 2006/046558 A1 and the related EP 1 847 869 A1 pertain to the edge processing of eyeglass lenses. A determination of geometric data or production data from the desired optical data is not carried out. Rather, this is a question of the adaptation of an eyeglass lens to an eyeglass frame here.

### SUMMARY OF THE INVENTION

The object of this invention is to indicate an apparatus and a method for processing an optical lens, whereby processing can be done in particular on the spot, for example right in an optician's office or the like, and/or at low organizational expense.

The above object is achieved by an apparatus according to claim 1 or by a method according to claim 25. Advantageous further developments are subjects of the subclaims.

Within the scope of this invention, the term desired “optical data” relates to the optionally highly individualized optical data of the lens that are determined for the respective patients, which are typically determined by an optician, or to the optical nominal data of the lens that is to be produced. In particular, in this invention, the “optical data” comprise the spherical optical action, for example in diopters, information regarding a cylinder for correcting astigmatism (for example, thickness of the curvature, in particular in diopters and position of the cylindrical axis, for example in degrees), information regarding a prism, in particular for correcting strabismus (for example, tilting or thickness of the prism, position and shape of the prism, axis of the prism, or the like), information regarding a near and/or far range, the interpupillary distance (distance between the eyes for the positioning of the lenses in the eyeglass frame), the fitting height (height from the lower edge of the lens to the center of the eye), the edge shape (for example round, indicating the diameter, or oval, indicating the minor and major axes of the ellipse or some other shape) and/or information regarding the angular position of the lens relative to the eyes or in the eyeglass frame (pantoscopic angle, face form angle to indicate the slope of the lens plane relative to the optical axis of the eye in the horizontal, etc.).

According to the invention, the term “geometric data” of the lens refers to the data or values that describe the geometric properties of the lenses, such as diameter, thickness, optionally at various points, radius of an optical surface or surface side, curvature in particular at various points, etc. The “geometric data” represent in particular the data or values that should or must have the (finished) processed lens or a surface of the lens to achieve the desired optical data or properties. The geometric data can refer, for example, only to one side, such as the front side or rear side of the lens, or at least to a side that is just about to be processed or finished, but also to both sides, the edge and/or the thickness or the thickness variation of the lens. For example, the geometric data can indicate or specify a desired surface variation or a desired surface shape, in particular a surface side, which is to be finished, of the lens that is to be processed. This can be carried out by, for example, corresponding parameters, such as the radius of a sphere and/or a torus, by a function, an approximation, by coordinate values, by CAD data and/or values corresponding thereto, or the like. The geometric data can also comprise, for example, a thickness, various thickness values, or a thickness variation of the lens that is to be finished. The geometric data can also comprise an edge path, in particular in the lens plane along the edge, and/or an edge shape, for example the design of one or more bezels along the edge, and/or the design of a groove (position, shape) along the outer edge, or the like. The geometric data are in particular data of the lens that is to be finished, i.e., threshold (set point) data or values, or the like, even when partially only an approximation and not a complete mathematical description or functional representation is possible.

In particular, the geometric data and the processing work thus relate at least to a surface or flat side that is essential for the optical function in particular as an eyeglass frame and/or for reaching the desired optical data, especially preferably the front side and/or rear side, of the lens. This invention in particular deals with the production of lenses with free-form surfaces, whereby “free-form surfaces” in terms of this invention are distinguished in particular in that no closed mathematical representation or only an approximate mathematical representation, for example by bicubic or higher splines, or the like, is possible. Especially preferably, the front side and/or rear side that is to be finished or processed is such a free-form surface.

According to the invention, the term “production data” refers in particular to the data with which preferably a specific processing device is actuated to implement a specific processing process. These are in particular data that control the movement of corresponding processing tools and/or corresponding processing processes. For example, the production data can be so-called CNC data, or the like. As an alternative or in addition, for example, the production data can also represent or comprise and contain geometric data from intermediate steps in the processing or different processing processes and/or optionally completely replace the geometric data.

In addition, the geometric data and/or production data in each case also contain or take into consideration a certain oversize or a possible undersize—in particular with respect to the subsequent processing steps, such as grinding, polishing, or coating.

According to the invention, “design model” is defined in particular as that which is called “lens design” among experts. The design model can be specific to a distributor of lens blanks. In particular, it comprises all of the algorithms or essential algorithms with which the geometric data of the special lenses are established or determined or approximated from the desired optical data. The geometric data depend in particular on the lens material, the refractive index, size, shape, thickness, lens type, manufacturer and/or the type of binding, or the like (the latter or similar information that relates in particular to the lens blank or the lens in the initial state or before the processing and/or an unambiguous identification are preferably referred to, according to the invention, as “output data, (starting data)” which in particular are lens-specific), and/or optionally on possible approximations of the design model. On the way from the lens blank to the finished lens, optionally various methods can also be pursued. The specifically selected processing method of the respective manufacturer of the lens blank and/or the processing machine is electronically usable or is taken into consideration in particular in the design model and/or in the generation of the production data.

The “design model” can also be defined according to the invention as a synonym for an algorithm or set of rules for determining or generating—in particular by calculation or approximating a front side or rear side of the lens that is to be processed—the geometric data or production data, especially preferably for production or processing of a front side and/or rear side of the lens to be produced, based on the desired optical data and in particular based on output data, which contain in particular at least the shape of an already finished rear side or front side of a lens that is to be processed.

Within the scope of this invention, “processing device” in general is defined as any device that provides or allows for a processing of the lens. In this respect, the term “processing device” also comprises a polishing device, a cleaning device, and/or an engraving device. In special cases, however, there is also the concept of “processing device for cutting processing (machining) or other shape-giving processing of the lens.” These are in particular the above-indicated special processing devices with a milling tool, with a turning tool, or with another shape-giving processing tool.

One aspect of this invention lies in the fact that the apparatus for processing (working) an optical lens not only has a processing device for cutting or other shape-giving processing of the lens and optionally a polishing device for polishing the lens, but also an input device for the desired optical data of the lens. The control device of the device is designed to generate lens-production data from the input desired optical data and/or to determine geometric data of the lens from the desired optical data.

Thus, in a simple way and at low cost, in particular also by less trained staff and/or on the spot and/or without connection to a host computer and/or without ordering raw glass, an (immediate) processing of the lens or a directly available lens can be achieved in such a way that the finished lens has the desired optical data and thus the desired optical properties. The desired optical data of the lens that is to be produced that are determined by the optician can be introduced in a simple way. An operator needs to input only these data and optionally output data from the lens that is to be processed or the lens blank to produce the lens with the desired optical properties. The additional data sets, which are subordinate to the desired optical data, are produced by the device itself.

The input device preferably has a control panel for manual input of the desired optical data. This allows for a very simple input and can be achieved at low cost. A control panel for manual input of the desired optical data is in particular a keyboard or a touchscreen.

As an alternative or in addition, the input device can also have an interface for an electronic input or receptacle of the desired optical data, in particular directly from a measuring device, computer, or the like.

Preferably, the input device or device, in particular for menu navigation of the user, also has a display device, in particular in the form of a dialog box or a screen, possibly equipped as a touchscreen. By means of the menu navigation, a user can operate the device via the control panel in a simple way, in particular without special instruction.

The apparatus or control device preferably has a design module with a design model for determining geometric data of the lens from the desired optical data in a determination process. This represents a significant simplification relative to the state of the art. In particular, an integration of the design module or design model (lens design) is provided in a machine control unit of a processing device. This simplifies the structure and reduces the cost to an extraordinary extent.

“Design module” is defined in particular as a data-processing device, computing device or computing unit, which can be formed or produced especially preferably by a separate computer and/or by software or a computer program, or the like.

The design module is used to determine the geometric data of the lens and/or the generation of production data. In this connection, the design module uses at least one design model in the already mentioned sense. The design model can be completely preset, programmed and/or changeable as desired. If necessary, several or different design models can also be used.

The design model can especially preferably be preset, programmed and/or changed. This allows for a universal use and/or an adaptation to the respective conditions and various lenses, lens manufacturers and/or customer demands.

According to one variant, the design model can be selected to determine geometric data of the lens from the desired optical data from several design models—in particular automatically based on the lens or on the lens type or lens blank. This allows for an optimum adaptation or selection.

“Determination process” is preferably defined as the determination of the geometric data or generation of production data for a lens that is to be processed. In this connection, several determination or generation steps can also be performed or occur. These are defined, evaluated, counted or acquired altogether as a single determination process if the latter all refer to the same lens.

The apparatus or control device preferably has a production module for generating production data at least for a processing device of the apparatus and, once there, for the polishing device from the previously determined geometric data of the lens. Thus, at low cost, a direct further processing of the specific geometric data can be carried out. In particular, transfer problems can be avoided. This further simplifies the operation and handling.

“Production module” is defined in particular as a data-processing device, computing device or computing unit, which can be formed or produced especially preferably by a separate computer and/or by software or a computer program, or the like.

As already mentioned above, the production module can be eliminated or can be integrated into the design module when the design module is generated directly or else the (necessary) production data are generated. As an alternative or in addition, however, at least one production module can also be provided for generating production data.

The apparatus is especially preferably designed as a compact processing center. In principle, DE 10 2007 007 188 A1 already shows a device in the form of a processing center. There, however, nothing is explained regarding the control device and the input device.

The apparatus according to the proposal in particular has a common housing for at least one processing device of the apparatus as well as for other optional devices for polishing, cleaning, marking and/or locking. This allows for an especially compact and/or economical structure and/or a simplification of the expense, the control, and/or the operation. Otherwise necessary external interfaces for transfer of data or transmission of information can also be minimized or completely avoided.

The control device, the design module, and/or the input device is/are especially preferably integrated into the device or firmly connected to the latter. This corresponds to the preferred formal principle of the compact processing center according to the proposal. However, the control device and/or input device according to a variant embodiment can also be designed as a separate component or subassembly that in particular can be connected directly to the device and that then is designed preferably but decidedly for the apparatus and can be connected very simply and in particular exclusively to the latter.

A configuration of the apparatus, in which the lens or the lens blank, in particular locked on a block piece, can be manually inserted into or clamped onto the processing device and, once there, can be put into the polishing device and can be removed again from the latter, is especially advantageous. The same is true here in particular also for the cleaning device. This corresponds to a simple design that can be easily handled at the site where the device is used. As a result, the costs of the device are considerably dropped, since costly, complicated handling devices for the lens or the lens blank, preferably on the block piece, can be eliminated.

A method for processing an optical lens according to the proposal is distinguished in that a lens that is to be processed, in particular, i.e., a lens blank, is fed to a apparatus, and desired optical data of the lens can be input into the apparatus, whereby geometric data of the lens are determined from the desired optical data and production data are generated therefrom or direct production data are generated, and the lens is processed based on the generated production data from the apparatus. An external influence or disruption of the determination of the geometric data, the generation of the production data, the data-processing and/or the data transfer to the processing device(s) after the input of the optical data and/or optionally after a start-up or an optional initial release, is/are especially preferably no longer possible. This allows for a processing of lenses on the spot at low cost, whereby the operation is significantly simplified and can be reduced in particular to the direct input of the desired optical data and optionally output data.

Preferably, a cutting, in particular a turning processing of a front side and/or rear side of the lens and then a polishing of the processed lens are carried out in the apparatus.

Especially preferably, the lens that is to be processed already has a finished or processed or formed side, in particular the rear side. The other side of the lens is processed (worked) shape-giving, in particular cutting, in the processing device, whereby the geometric data and/or production data of the side of the lens that is to be processed are determined from the desired optical data of the lens and based on the shape of the already finished side of the lens and are used for the processing.

According to the proposal, preferably (only) directly available or present lenses are processed, in such a way that a remote transmission of lens data, common in the state of the art, and lens ordering with a glass manufacturer (can be) are no longer necessary.

Some of the previously-mentioned and subsequent aspects and features of this invention can be combined with one another in any way desired, but they can also be produced independently of one another.

Other aspects, features, advantages and properties of this invention follow from the claims and the subsequent description of a preferred embodiment based on the drawing. Here:

### BRIEF DESCRIPTION OF THE DRAWINGS

FIG. 1 shows a diagrammatic structure of a apparatus according to the proposal;

FIG. 2 shows a diagrammatic view of the apparatus;

FIG. 3 shows a diagrammatically enlarged view of a lens on a block piece; and

FIG. 4 shows a diagrammatic view of a receiving device of the apparatus with a group of lenses.

### DETAILED DESCRIPTION OF THE INVENTION

The subject of the invention is an apparatus 1 for processing an optical lens 2. For the technological background of such an apparatus, reference must first be made to the introduction of the description.

The starting point for the development or processing of an optical lens 2 is a lens blank. The latter is processed by cutting processing (machining) or in other shape-giving processing (working) and optionally in additional processing steps, in such a way that at the end, there is a finished optical lens 2 with the desired optical properties. Within the scope of this description, the term “lens” refers preferably both to the lens blank, before the necessary processing steps are performed, and to the finished lens 2, at the end.

The lens 2 or the lens blank preferably consists of plastic. However, in principle, another material that can be processed in a suitable way, optionally also glass can also be used. If the finished lens 2 is used or is to be used for eyeglasses (not shown), which preferably is the case, the lens 2 in this invention is also referred to as an eyeglass lens, even when the lens 2 optionally does not consist of glass.

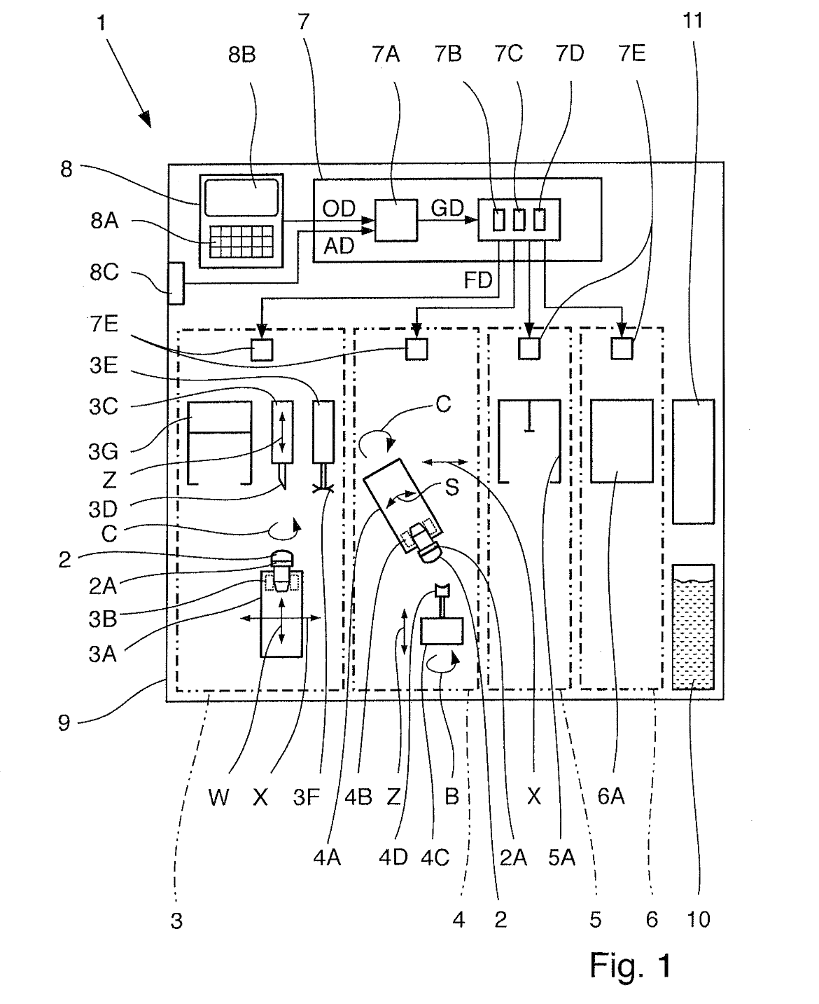

The apparatus 1 according to the invention has at least one or only one processing device 3 for cutting or other shape-giving processing of the lens 2 as the workpiece that is to be processed. This processing device 3 is indicated only diagrammatically in FIG. 1.

In the depicted and preferred embodiment, the processing device 3 preferably has a workpiece spindle 3A, which preferably can be moved in the W-direction and the X-direction, in particular by means of a recessed cross, which is only indicated. The two directions W, X preferably run crosswise or perpendicular to one another.

The workpiece spindle 3A is in particular a preferably direct-drive, precisely-mounted shaft or a direct drive or another drive in each case with a preferably integrated or assigned interface or receptacle 3B for the workpiece, i.e., here for the lens 2 or the lens blank. In principle, the lens 2 can be directly accommodated or clamped. Preferably, however, the lens 2 or the lens blank is held indirectly by a holding device, in particular a so-called block piece 2A. The block piece 2A is then clamped.

The lens 2 is temporarily connected to the block piece 2A. This state that is associated with the block piece 2A is referred to as “blocked” or “locked.” The locking, i.e., temporary fastening, of the lens 2 to the block piece 2A can be accomplished, for example, by a preferably low-melting alloy, such as a so-called alloy block material, a resin, an adhesive, a plastic, an adhesive strip, or the like and is sufficiently known from the state of the art.

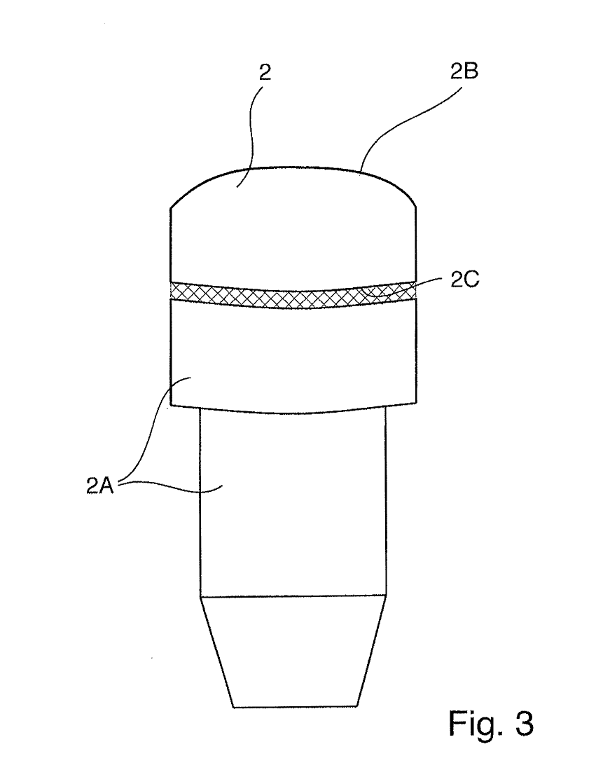

In a diagrammatically enlarged view, FIG. 3 shows the lens 2 with an assigned block piece 2A according to a possible embodiment. The lens 2 is thus locked here.

The lens 2 that is to be processed has at least one optical surface or flat side, here in particular a front side 2B, that is to be processed—preferably completely. The other optical surface or surface side, here the rear side 2C, is facing the block piece 2A in the illustrative example.

The opposite side of the lens 2 that is to be processed, here the rear side 2C, is preferably already finished or already processed or shaped. In particular, this side does not need any further shape-giving processing; instead, preferably only a shape-giving processing of the other side or front side 2B of the lens 2 is then done to obtain the desired optical data or properties of the lens 2. This is explained in more detail below.

In the illustrative example, as shown in FIG. 1, the workpiece spindle 3A preferably has the receptacle 3B, in particular a collet chuck, for the block piece 2A.

The clamping of the lens 2 or the block piece 2A on the workpiece spindle 3A or receptacle 3B is preferably done by hand, i.e., manually by an operator, not shown. In principle, however, an automated clamping is also possible.

The lens 2 or the block piece 2A can preferably be clamped in a specific axial position and/or rotating position to be able to process the lens 2 in a defined manner. To this end, the block piece 2A can also be constructed in several parts, as known in particular from the state of the art.

By means of the workpiece spindle 3A, the clamped lens 2 can be turned or rotated for processing. The workpiece spindle 3A thus forms in particular a rotary drive for the lens 2. The workpiece spindle 3A forms in particular a calculated or controlled rotary axis C. In particular, a CNC control unit of the workpiece spindle 3A or the rotation of the lens 2 is accomplished. Especially preferably, the lens 2 is controlled or adjusted at a specific speed and/or can be turned or rotated with a defined rotating position.

In the embodiment shown, the workpiece spindle 3A with the clamped or locked lens blank 2 can be advanced or positioned in a processing tool preferably in the W-direction and/or can be moved or transported in the X-direction crosswise to the direction of advance (crosswise feed). In particular, a controlled W-axis and X-axis or linear axes are formed. In principle, other, or additional, directions and/or movement axes are also possible. In particular, the axial orientation of the axis of rotation or rotary axis C of the workpiece spindle 3A can also run obliquely to the W-direction or to the X-direction.

The processing device 3 is preferably designed for processing (working) the lens 2 by turning, in particular front-turning (facing) and/or milling. However, the processing device 3 as an alternative or in addition can also make possible another—in particular cutting or shape-giving—processing of the lens 2.

In the illustrative example, the processing device 3 preferably has a drive 3C with a turning tool 3D and/or a milling drive 3E with a milling tool 3F. Here, in particular, i.e., the turning tool 3D or milling tool 3F is provided as a processing tool.

The lens 2 and the respective processing tool (here, turning tool 3D or milling tool 3F) can preferably be advanced and/or moved relative to one another to make possible the respective processing.

The drive 3C is preferably a complex, preferably electrically-operating axial drive, such as a moving coil drive, or the like, in particular a so-called fast-tool drive, to control or to quickly move back and forth the turning tool 3D in particular based on the rotating position of the lens 2 and/or based on the distance of the turning tool 3D from the axis of rotation of the workpiece spindle 3A in its axial position or Z-axis. The drive 3C allows for a preferably linear and/or controlled or regulated movement of the turning tool 3D and therefore preferably forms a controlled Z-axis.

The direction of the Z-axis, on the one hand, and the direction of the W-axis or the axial orientation of the axis of rotation or rotary axis C, on the other hand, can run parallel to one another or tilted relative to one another and/or can be adjusted relative to one another. With a relative slope, the latter is preferably small enough that the preferred front-rotation for processing the workpiece or the lens 2 can still be done in the desired or necessary way.

In this invention, the Wan “axis” is especially preferably defined in terms of the terminology in CNC control units (digital or computer-controlled control units) as a controlled or regulated or calculated movement axis, such as a linear axis or rotary axis. This applies in particular for some or all parts of a processing device and/or multiple processing devices or for the apparatus 1 as a whole according to the proposal.

The milling tool 3F and the assigned milling drive 3E are indicated only diagrammatically in FIG. 1. The orientation of the rotational axis or axis of rotation of the milling tool 3F preferably runs crosswise or perpendicular to the axial direction of the axis of rotation or rotary axis C of the workpiece spindle 3A. Depending on requirements and design with its orientation of the axis of rotation, the milling tool 3F can also be oriented or can pivot obliquely inclined in the axial direction of the axis of rotation or rotary axis C of the workpiece spindle 3A and/or can be advanced relative to the lens 2, for example by corresponding movement of the workpiece spindle 3A and/or the milling drive 3E or the milling tool 3F.

In the depicted and preferred embodiment, the processing 3 is preferably accomplished in two stages, in particular carried out with a milling tool 3F operating in a coarser mode for coarse processing (pre-processing) and a turning tool 3D operating in a finer mode for finer processing (fine processing or main processing). If necessary, however, the processing by milling can also be completely eliminated. This results in a simplification of the apparatus 1 or processing device 3 and allows for a more compact and/or more economical structure. If necessary, the turning can also be accomplished in two steps, such as a coarser preliminary turning and later fine turning, preferably with the same turning tool 3D, but optionally also with different turning tools.

In particular, a processing can be accomplished, for example, in the processing device 3, or a structure can be provided, as described in EP 0 849 038 A2 or DE 10 2009 011 194 A2, for example.

The cutting or shape-giving processing is accomplished preferably by adding fluid, such as a cooling emulsion, or the like.

The apparatus 1, here in particular the processing device 3, preferably also has a marking device 3G, for example a laser, to mark the lens 2, for example, with corresponding data, marks, or the like. The marking device 3G is preferably depicted, constructed and/or designed as in EP 1 955 811 A1.

If necessary, a (first) edge processing of the lens 2 is also accomplished in the processing device 3. However, as an alternative or in addition, an additional processing device, not shown, such as a so-called edger, or the like, can also be provided for the edge processing.

It is also possible that the apparatus 1 or processing device 3 is designed in such a way that the lens 2 can be processed in a cutting or shape-giving way again after the actual shape-giving processing—of the optical surface(s) or flat side(s) of the lens 2, especially preferably the front side 2B—and after a coating, in particular for the edge processing of the lens 2 or finishing the edge of the lens 2.

In addition to the processing device 3, the apparatus 1 preferably has a polishing device 4 for polishing or finishing the lens 2 or this lens blank that is processed in advance in the processing device 3. In the embodiment depicted in FIG. 1, the polishing device 4 is arranged preferably adjacent to and/or laterally beside the processing device 3.

The polishing device 4 can have a common housing with the processing device 3 or a housing that is separate therefrom.

The polishing device 4 is constructed or designed especially preferably as described in DE 10 2007 042 667 A1, whereby the polishing device 4 according to this invention can be designed, if necessary, also only for processing a lens 2 and not for simultaneous processing of two lenses 2; in particular, it can have, i.e., only one drive for rotating the lens 2.

In the illustrative example, the polishing device 4 preferably has a workpiece spindle 4A with a receptacle 4B. The workpiece spindle 4A can be constructed in principle similar to or in the same way as the workpiece spindle 3A in the processing device 3 and/or can be moved in the X-direction (crosswise feed) and/or can be pivoted as indicated by arrow S. In addition, reference is therefore made to the workpiece spindle 3A in the description. In particular, the workpiece spindle 4A is also used as a drive to rotate the lens 2 for the processing, here the polishing, and/or it serves to advance the lens 2 to a polishing tool 4D. In particular, the workpiece spindle 4A is a simple rotary drive, for example a motor with a belt drive to rotate the lens 2 for the processing or the polishing. Especially preferably, the lens 2 or the block piece 2A is mounted without a defined rotating position and/or only rotated at a constant speed (optionally controlled or regulated depending on requirements).

In principle, the polishing can also be carried out only after unblocking, i.e., after the lens 2 is detached from the assigned block piece 2A. In this case, the lens 2 is preferably directly clamped.

The clamping of the lens 2 or the block piece 2A in the workpiece spindle 4A or the receptacle 4B thereof is preferably carried out in turn by hand, i.e., manually by an operator, not shown. Accordingly, a manual reclamping from the workpiece spindle 3A to the workpiece spindle 4A is preferably also carried out. In particular, just like the clamping per se, in principle this reclamping can also be carried out in an automated manner or automatically by means of a corresponding handling or clamping device (not shown) by the apparatus 1.

The separate drive or workpiece spindles 3A and 4A and/or receptacles 3B and 4B for the processing device 3, on the one hand, and the polishing device 4, on the other hand, make possible an independent processing (the polishing is also defined as processing, in particular as finishing) in the two devices 3 and 4, in such a way that the throughput of the device 1 on the processed lenses 2 is correspondingly higher compared to a common workpiece spindle for both devices 3 and 4. However, in principle, instead of the separate or additional workpiece spindle 4A for the polishing device 4, only one or the workpiece spindle 3A can be used together for the two devices 3 and 4. If necessary, the polishing in the polishing device 4 can also be accomplished simultaneously for multiple lenses 2 at the same time and/or in multiple processing steps.

The polishing device 4 preferably has at least one polishing drive 4C with at least one assigned polishing tool 4D as a processing tool. The polishing drive 4C can turn the polishing tool 4D in particular, as indicated by arrow B.

Especially preferably, the polishing tool 4D can be pressed against or mounted on the lens 2 that is to be processed or the workpiece in particular with a predetermined force, here in the Z-direction in the illustrative example. The pressing or mounting can be accomplished, for example, pneumatically, by spring force and/or in another suitable way.

In addition or as an alternative, the polishing drive 4C or the polishing tool 4D can, if necessary, also be moved or slid in the X-direction, i.e., can form or have in particular a controlled X-axis, in particular for relative adjustment (crosswise feed) relative to the workpiece or to the lens 2.

In addition or as an alternative to the possible pivoting movement S of the workpiece drive or the workpiece, the polishing tool 4D can preferably be adapted or mounted via a corresponding joint, such as a ball joint or a gimbal joint, in its slope via a joint onto the surface of the lens 2 that is to be processed.

A single polishing drive 4C is depicted with a single polishing tool 4D. Of course, multiple drives and/or tools can also be used. In particular, the polishing drive 4C can also be designed or mounted with multiple axes. For example, the polishing device 4 can be designed or operated as described in DE 10 2007 042 667 A1.

The polishing is preferably accomplished by lapping, in particular, i.e., using a corresponding fluid containing friction elements, such as a so-called polishing milk, or the like. As an alternative or in addition, the polishing can also be done by fine grinding. In particular, instead of lapping, only a pure fine grinding can also be done for finishing the lens 2 in particular before a subsequent coating of the lens 2.

The polished or finished lenses 2 are preferably coated, in particular by means of the apparatus 1 or a coating device arranged therein (this would preferably also depict a processing device in tee is of this invention) or another device (not shown).

In principle, workpieces and tools can also be replaced or mixed up in the processing work that is described, in particular in the cutting or shape-giving processing and/or in the polishing, or a kinematic reversal can be provided.

The apparatus 1 optionally further has a cleaning device 5 with a cleaning space 5A, in which the previously processed lens 2 can be cleaned. The cleaning device 5 is designed to be separate here according to the preferred teaching—i.e., separate from the devices 3 and 4. In principle, it can also be integrated into, for example, the polishing device 4.

The cleaning is preferably done manually, i.e., in a non-automated manner. For example, the still locked lens 2 or the lens 2 that is already detached from the assigned block piece 2A after the processing, in particular after the stretching processing in the processing device 3 and/or after the polishing in the polishing device 4, is cleaned, preferably washed or rinsed, in the cleaning device 5. However, if necessary, the cleaning can also be accomplished in an automated manner and/or automatically and/or using a handling device, not shown, and/or one of the workpiece spindles 3A or 4A, or crosswise slots.

As an alternative or in addition, apparatus 1 can have an additional processing device 6, indicated by way of example, with another processing space 6A or even multiple additional processing devices 6, in particular also for different purposes or processing work. In the additional processing device 6, for example, a coating, optionally also multiple coatings, of the specially processed lens 2 can also be applied, as already mentioned.

As an alternative, a locking of the lens 2 on the assigned block piece 2A and/or an unblocking of the lens 2 and/or a processing of the lens edge and/or the block piece 2A can be accomplished in the additional processing device 6 or an additional processing device (not shown). Relative to the optional processing of the block piece 2, it is to be noted that in this connection, especially cutting or other shape-giving processing can be provided, for example to adapt the block piece 2A to a lens 2 that is to be processed specially, for example with an additional prism for correction of strabismus. This or another processing of the block piece 2 can be accomplished in the additional processing device 6 or an additional processing device, not shown, and/or in the processing device 3, whereby depending on requirements, an additional processing tool can also be used with an optional additional drive.

As an alternative, in the additional processing device 6 or an additional processing device (not shown), a measuring or gauging, for example, of the lens 2, an assigned eyeglass frame, a reference lens and/or a tool can be accomplished. The lens 2 can be gauged, for example, before and/or after a processing or a processing step. For example, a processed side, the front side and/or rear side of the lens 2 and/or an edge or edge path or outer edge path of the lens 2 can be measured or gauged. In the case of an eyeglass frame, for example, the shape of the frame, the inside contour for accommodating the eyeglass lenses, and/or the distance from the eyeglass lenses can be measured.

The apparatus 1 has a control device 7 in any case for controlling the shape-giving processing of the lens 2 or the processing device 3 and, once there, the polishing device 4. The control device 7 can also control additional devices 5 and 6 of the apparatus 1. The control device 7 is diagrammatically indicated in FIG. 1. Details of the control device 7 are further explained below.

The control device 7 is provided or connected on the input side with an input device 8 of the device 1, which is configured in such a way that the desired optical data OD of the lens 2 can be input directly. The optical data OD, which are input with the input device 8, are relayed to the control device 7, which determines preferably geometric data GD of the lens 2 therefrom and/or determines or generates lens-production data FD.

In the embodiment, the input device 8 preferably has a control panel 8A for manual input of the desired optical data OD and/or a display device 8B, here in the form of a screen, in particular for user guidance. If necessary, the input device 8 can also have a touchscreen as an alternative or in addition to the control panel 8A for input of the desired optical data OD. This touchscreen can, if necessary, be formed by the display device 8B and/or an additional screen. It is important that the input device 8 be designed in such a way that the optical data OD can be input in a simple, easily comprehensible way.

The display device 8B preferably uses user guidance in the input of desired optical data OD and/or for an (easy) operation of the device 1. The device 1 especially preferably has only a single display device 8B or only a single screen to make possible a simple, economical structure and/or to make possible or to facilitate an especially simple operation, even by at least largely unskilled staff.

In the display device 8B, a dialog box preferably can be in particular a touchscreen. Then, the control panel 8A, which is indicated as a keyboard in FIG. 1, is in actuality integrated into the screen 8B. Of course, a rather traditional configuration with a (separate) keyboard as a control panel 8A is also possible as well.

A variant in which the input device 8 has an interface 8C, in particular for an electronic input or receptacle of the desired optical data OD, is also indicated in FIG. 1. In this connection, for example, this can be a card reader, a wireless interface, or an electrical connection, such as a USB interface.

The apparatus 1 or control device 7 preferably has a design module 7A for determining or generating geometric data GD and/or production data FD from the desired optical data OD. FIG. 1 can detect how the optical data OD from the input device 8 preferably are relayed to a first stage of the control device 7, namely to the design module 7A. In the depicted and preferred embodiment, the design module 7A contains (at least) one design model, with whose assistance geometric data GD of the lens 2 to be produced are developed or generated from the input optical data OD in a determination process. The design model or a group of preferably stored design models results in particular in the design module 7A preferably with the structure of algorithms explained in the general part of the description or by an approximation, interpolation, or the like to than the geometric data GD of the lens 2.

The desired optical data OD were already explained or defined in the general description of the invention, in such a way that a repetition in this connection is unnecessary. The same is also true for the geometric data GD and the production data FD.

From the desired or input optical data OD, the geometric data GD in a first step and the production data FD in a second step or, as an alternative, also directly the production data FD—optionally also different production data FD for different processing steps—are established, determined and/or generated by the device 1, by the control device 7, and/or by means of the design module 7A or design model. In this connection, in particular also the output data AD of the lens 2 that is to be processed or the lens blank that is to be processed, such as lens type, size, shape, thickness, lens material, refractive index, shape of an already finished side, such as the rear side 2C and/or the type of binding, or the like, are taken into consideration. If necessary, these output data AD can be input and/or selected in particular via the input device 8 and/or interface 8C, as indicated in FIG. 1, or in another way, and/or automatically acquired or determined by the device 1 or control device 7. In particular, the control device 7 or the design module 7A can select a corresponding or suitable design model based on these output data AD.

As an alternative or in addition, the apparatus 1 or the control device 7 and/or the design module 7A can be designed in such a way that based on the optical data OD and/or the geometric data GD resulting therefrom, a lens 2 or the optimum lens blank or lens type—in particular from a preset or presettable group of available lenses 2 or lens blanks or types—can be selected automatically and optionally can be indicated in particular to the operator.

The operator can then clamp the corresponding lens blank in the first processing device, here the processing device 3 or its workpiece spindle 3A or its receptacle 3B. If the required lens blank specifically should not be available, the operator can input the latter preferably so that then another suitable lens blank can be requested from the device 1 or control unit 7. However, other processes or user guidance are also possible here. It is to be noted that the term “user guidance” in particular comprises the guidance of an operator, not shown, especially preferably via the display device 8B or other devices, with respect to the operation of the device 1 and/or supplying resources, tools, or the like.

The design model can be preset, programmed and/or changed; this depends in particular on the configuration of the control device 7 or the design module 7A. Preferably, a specific group of design models is stored in the apparatus 1, in the control device 7, or in the design module 7A, and can be selected from these design models, if necessary.

The determination of the lens data or geometric data GD from the optical data OD is accomplished according to the preferred teaching, in such a way that for each lens 2, a particular determination process for the geometric data GD or production data FD is carried out. A separate determination process for determining the geometric data GD from the optical data OD or, directly, the production data FD from the optical data OD for each individual lens 2 is of special importance, also to be able to generate an unambiguous accounting. Each determination process of geometric data GD or production data FD is preferably counted and cleared and/or only carried out as a separate determination process when a corresponding activation code FC or another release or the like is present. The device 1 or control device 7 or the design module 7A is preferably designed in such a way that a determination process is carried out only after a corresponding release and/or each determination process is counted and/or cleared. The input or acquisition of a corresponding activation code can be accomplished in particular via the input device 8 or the interface 8C or in another suitable way.

According to preferred teaching, the apparatus 1 or the control device 7 preferably further has a production module 7B, with which the production data FD for the processing device 3 and optionally also for the polishing device 4 are now generated from the specific geometric data GD of the lens 2. Also, for the additional processing devices 5 or 6 of the apparatus 1, the corresponding production data FD can be generated by means of the production module 7B.

In addition, in the depicted embodiment, a distribution of the production data FD is preferably carried out in various processing steps. This can be accomplished, for example, via a sequence control unit 7C, indicated in FIG. 1, of the apparatus 1 or control unit 7 and/or in some other way, optionally by means of additional control devices.

In the apparatus 1 or control device 7, a user guide device 7D can also be integrated, which then makes possible—in particular via the display device 8B of the input device 8—the feedback to the user or operator or the user guidance.

In principle, it is also possible to be able to produce or to generate the production data FD without the intermediate step of the geometric data GD of the lens 2 directly from the desired optical data OD of the lens 2, as already mentioned. This depends in particular on the configuration and/or programming of the apparatus 1 or control device 7.

In the depicted and preferred embodiment, each individual device 3, 4, 5 and 6 preferably has its own assigned device control unit 7E. These device control units 7E are integrated in the depicted and preferred embodiment, preferably into the respective devices 3, 4, 5 and 6. They can also, however, be integrated at least partially or completely into the control device 7 or other components of the apparatus 1 or can be formed therefrom. Usually, the device control units 7E are CNC control units.

In general, it is to be noted that the control device 7 can be formed by or can contain a memory-programmable control unit, CNC control unit (digital or computer-supported control unit), or the like, and/or can control such a control unit. The control device 7 or parts of the control unit can also be combined arbitrarily for the devices 3 to 6 and/or divided arbitrarily among the devices 3 to 6 or can be formed only by the latter.

The depicted and preferred embodiment shows the apparatus 1 as a compact processing center, here and according to preferred teaching in or with a common housing 9. As a result, the apparatus 1 according to the invention can be installed preferably completely with all devices on a suitable spot. In particular, here, this is a compact apparatus 1 in the form of a processing center that can be set up on any site.

Preferably, the control device 7 and/or the input device 8 is/are firmly embedded, integrated or thus firmly connected and/or firmly attached thereto—in particular via a cable, not shown—in the apparatus 1 or its housing 9.

The depicted and preferred embodiment also shows, diagrammatically indicated in FIG. 1, another tank 10, in which a necessary fluid, for example a polishing agent, a cleaning fluid, a cooling lubricant, or the like, can be stored. Consequently, the tank 10 can also be divided, if necessary. The tank 10 can also be formed or supplemented by multiple individual tanks that are separate from one another.

Finally, FIG. 1 also shows, diagrammatically indicated, another receiving device 11, which can be used, for example, for storing tools, block pieces, lens blanks, or the like.

According to the preferred teaching of the invention, the apparatus 1 can also be configured in such a way that the state of the apparatus 1 and/or individual devices 3 to 6 of the device 1 and/or other informational data, such as the number of determination processes, the type or number of the processed lenses 2, or the like, can be queried and/or influenced from afar. This uses in particular monitoring or maintenance, but in particular it is not intended for the continuous operation of the apparatus 1. To this end, corresponding interfaces can then be provided for connection to the Internet, to a telephone network or a radio network (for example, via a preferably integrated GSM module) or some other network. In this connection, the interface 8C optionally also can be used.

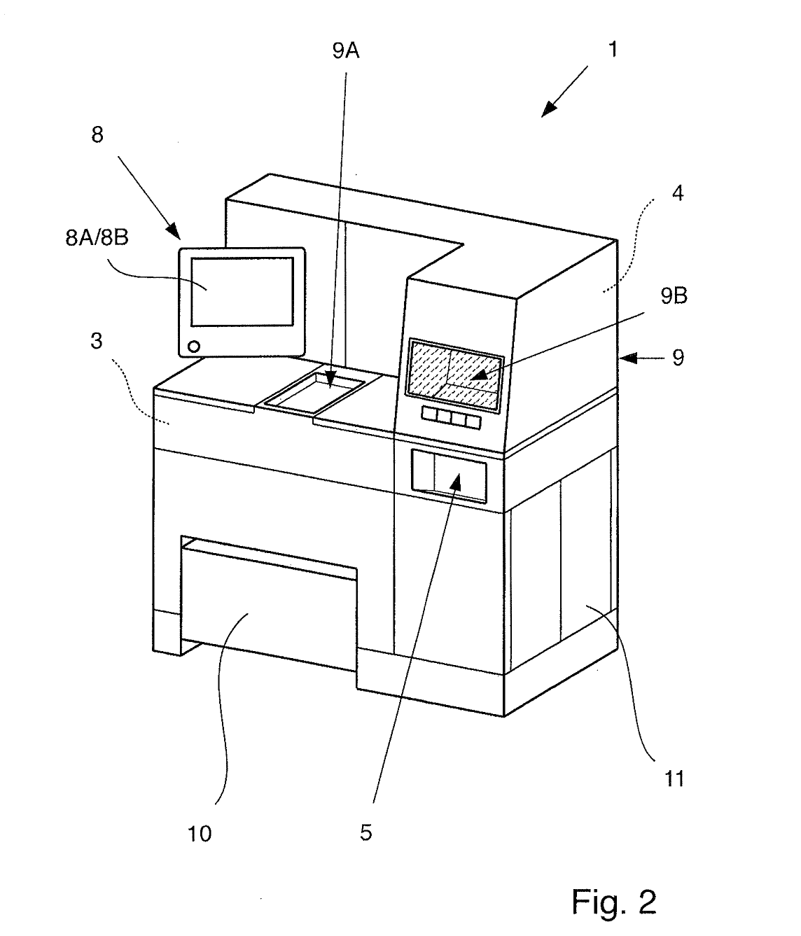

In a diagrammatic, perspective view, FIG. 2 shows the apparatus 1 according to the invention in a possible configuration in the form of a processing center in the compact housing 9. The housing 9 preferably has an input flap 9A for the processing device 3, here only indicated, that is located in particular below in the housing 9. The polishing device 4 is preferably arranged on the right in the housing 9. An input flap 9B for the polishing device 4 is provided on the housing 9 in the front in the area of the polishing device 4. As an alternative, the input flap 9B can also be arranged, for example, beside the input flap 9A at least essentially at the same height or in a common plane and/or with an at least essentially identical orientation, whereby the polishing device 4 then is arranged preferably under it and not behind it.

Based on the representation in FIG. 2, it can be seen that the reclamping of a lens 2 or a lens blank with its block piece 2A from the processing device 3 is preferably accomplished manually in the polishing device 4 by an operator.

An opening of the cleaning device 5 is preferably arranged below the input flap 9B or the polishing device 4 or at some other suitable spot. The tank 10 is indicated or arranged preferably below on the housing 9. The input device 8 with the display device 8B and/or the control panel 8A, here in particular in the form of a touchscreen, is preferably located on the top left on the housing 9.

The apparatus 1 or its housing 9 preferably also has the receiving device 11, in particular for tools, block pieces 2A, lenses 2, or lens blanks, and/or other resources. The receiving device 11 here in the illustrative example is preferably arranged laterally.

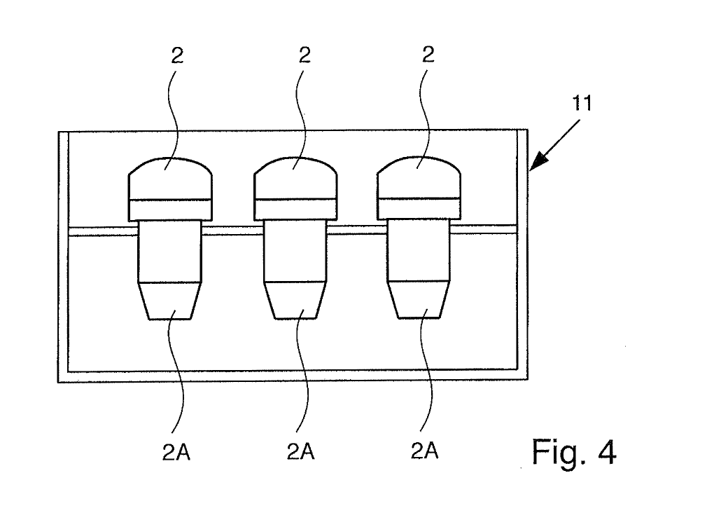

In a diagrammatically enlarged view, FIG. 4 shows the receiving device 11 with a group of preferably already locked lens blanks or lenses 2 for the processing in the—or by means of the—apparatus 1. This is thus a group of available or existing lenses 2 here. Especially preferably in this connection, these are different lens blanks or lens types or lenses 2 with differently formed rear sides 2C, diameters and/or thicknesses and/or other different output data AD. As already mentioned, the device 1 is preferably designed in such a way that based on the desired optical data OD and taking into consideration the output data AD of these lenses 2, a lens 2 that is especially suitable or optimum for the processing can be selected and in particular can be displayed. The selection can be carried out from the group of the already present lenses 2 or from a group of generally available lenses 2. In particular in the last-mentioned case, the different output data AD from the various lenses 2 can be input or stored in advance. Otherwise, these output data AD optionally have to be acquired or input from the currently available lenses 2.

Individual features of the various processing devices and/or the device 1 or the control unit 7 can also be produced independently of one another and in any combination.

What is claimed is:

1-36. (canceled)

37. Apparatus for processing an optical lens, with a processing device for cutting or other shape-giving processing of a front side and/or rear side of the lens, with a control device for controlling the processing device and
with an input device, which is configured in such a way that the desired optical data of the lens can be input directly,
wherein the control device is designed for generating lens-production data from the input desired optical data for the processing of the front side and/or rear side for reaching the desired optical data with the lens, or
wherein the control device is designed for determining geometric data from the desired optical data for the processing of at least one of the front side and/or rear side for reaching the desired optical data with the lens.

38. Apparatus according to claim 37, wherein the input device has a control panel for manual input of the desired optical data.

39. Apparatus according to claim 37, wherein the input device has an interface for an electronic input or pick-up of the desired optical data.

40. Apparatus according to claim 37, wherein the input device has a display device, preferably in the form of a dialog box or a screen, in particular a touchscreen, for user guidance.

41. Apparatus according to claim 37, wherein the control device has or uses a design module with a design model for determining geometric data or production data of the lens from the desired optical data.

42. Apparatus according to claim 41, wherein the design model can be preset or programmed or changed.

43. Apparatus according to claim 41, wherein the design model can be selected from several design models.

44. Apparatus according to claim 41, wherein the device or control device is designed in such a way that the design model can be selected based on lens-specific output data of the lens that is to be processed.

45. Apparatus according to claim 41, wherein the device or control device is designed in such a way that the design model can be selected based on a manufacturer of a lens that is to be processed or the lens type.

46. Apparatus according to claim 41, wherein the determination of the geometric data or generation of the production data from the optical data is acquired as a determination process or forms such a process.

47. Apparatus according to claim 46, wherein the device is designed in such a way that for each lens, only a single determination process is acquired.

48. Apparatus according to claim 46, wherein the device is designed in such a way that a determination process is carried out only after a corresponding release.

49. Apparatus according to claim 46, wherein the device is designed in such a way that each determination process is counted or cleared.

50. Apparatus according to claim 37, wherein the control device has a production module for generating production data at least for the processing device from the determined geometric data of the lens.

51. Apparatus according to claim 37, wherein the apparatus is designed as a compact processing center, in particular in or with a common housing.

52. Apparatus according to claim 37, wherein the control device is integrated into the apparatus or firmly connected to the latter.

53. Apparatus according to claim 37, wherein the input device is integrated into the apparatus or firmly connected to the latter.

54. Apparatus according to claim 37, wherein the device has a polishing device for polishing the lens that is processed by the processing device, in particular whereby the polishing device can be controlled by the control device.

55. Apparatus according to claim 37, wherein the apparatus or the control device is designed in such a way that the geometric data or lens-production data for the processing of the—preferably entire—front side are determined or generated from the input desired optical data and based on the shape of the rear side of the lens that is to be processed, in particular whereby only the front side of the lens is processed by means of the processing device, or vice versa.

56. Apparatus according to claim 37, wherein the apparatus or the control device is designed in such a way that based on the optical data or the geometric data that result therefrom, an optimum lens can be selected and in particular displayed from a preset or presettable group of available lenses that are to be processed, in particular with the already processed or formed rear side.

57. Apparatus according to claim 37, wherein the processing device is designed for at least one of cutting, turning and full-surface processing of the front side or rear side of the lens based on the geometric data and production data determined from the desired optical data.

58. Apparatus according to claim 37, wherein the processing device is designed for the production of a free-form surface on the front side or rear side of the lens.

59. Apparatus according to claim 37, wherein the processing device has a receptacle for a block piece of the lens, so that the latter, manually locked on the block piece, can be inserted into, clamped onto and processed at least in the processing device.

60. Method for processing an optical lens,
wherein a lens that is to be processed is fed to a apparatus and desired optical data of the lens are input into the apparatus,
wherein in the apparatus, geometric data of the lens are determined from the desired optical data, and production data are generated therefrom or production data are generated directly from the desired optical data,
wherein then at least one of a front and rear side of the lens is processed based on the production data that are to be generated from the device, in particular to impart the desired optical data to the lens.

61. Method according to claim 60, wherein the lens or at least one of the front side and rear side) thereof is processed by cutting or turning in the apparatus.

62. Method according to claim 60, wherein the lens is polished after the processing in the apparatus.

63. Method according to claim 60, wherein the desired optical data are input manually via an input device of the apparatus.

64. Method according to claims 60, wherein the desired optical data are input or picked up electronically.

65. Method according to claim 60, wherein the geometric data and/or production data are determined or generated from the desired optical data by means of a design model.

66. Method according to claim 65, wherein the design model is selected from several design models—in particular automatically or based on available lenses or lens blanks or lens types or lens manufacturers.

67. Method according to claim 60, wherein the determination of geometric data or generation of production data from the optical data is at least one of evaluated, acquired, stored and counted altogether as a determination process.

68. Method according to claim 60, wherein for a lens, the geometric data or production data are determined or generated only after a corresponding previous release or previous input of an activation code.

69. Method according to claim 60, wherein the geometric data or production data of the front side of the lens is/are determined or generated based on the desired optical data and based on the shape of the rear side of the lens.

70. Method according to claim 60, wherein the front side of the lens is processed based on the desired optical data and based on the shape of the rear side of the lens in the device.

71. Method according to claim 60, wherein the determination of the geometric data is integrated into the apparatus and is carried out in particular without remote data transmission or without external data exchange.
